(19) United States
(12) Patent Application Publication
(10) Pub. No.: US 2017/0185397 A1
(43) Pub. Date: Jun. 29, 2017

(54) ASSOCIATED INFORMATION GENERATION DEVICE, ASSOCIATED INFORMATION GENERATION METHOD, AND RECORDING MEDIUM STORING ASSOCIATED INFORMATION GENERATION PROGRAM

(71) Applicant: NEC Corporation, Minato-ku, Tokyo (JP)

(72) Inventor: Hiroshi SAKAKI, Tokyo (JP)

(73) Assignee: NEC Corporation, Minato-ku, Tokyo (JP)

(21) Appl. No.: 15/313,744

(22) PCT Filed: Jun. 5, 2015
(86) PCT No.: PCT/JP2015/002842

§ 371 Date: Nov. 23, 2016

(30) Foreign Application Priority Data
Jun. 13, 2014 (JP) 2014-121932

(51) Int. Cl. G06F 9/44; G06Q 10/10

(52) U.S. Cl. CPC G06F 8/77; G06Q 10/103

(57) ABSTRACT

Provided is an associated information generation device and the like that facilitated estimates relating to a project. The associated information generation device (101) has an associated information generation unit (102) that on the basis of project information including a task identifier is associated with a change causes are associate with the proportion at which the change causes occur identifies the change cause associated with a specific task identifier contained in project information, identifies the proportion associated with the identified change cause, and generates associated information in which the identified proportion and the identified task identifier are associated.

### TECHNICAL FIELD

The present invention relates to an associated information generation device that, for example, supports an operation of estimating man-hours needed for a project, and the like.

### BACKGROUND ART

A method for defining a software as standard components is an example of methods for improving development efficiency (productivity) of a project of developing software or a service. Further, a method for managing documents regarding software, such as design information regarding the software and template documents, and reusing the managed documents is an example of methods for improving the development efficiency.

Systems disclosed in PTL 1 and PTL 2 are examples of systems improving development efficiency of a project.

PTL 1 discloses an example of a management system managing information regarding a project. The management system includes a storage server retaining design information regarding software developed in a project, a generation terminal generating design information, and a management terminal.

First, a designer generates design information regarding software developed in a project by using a design specification generation terminal and stores the design information into a storage server. As the design information is updated, the designer generates a change history representing an updated content and the like, and stores the generated change history in the storage server. As the change history is requested, a management terminal reads the change history stored in the storage server and displays the read change history.

Further, PTL 2 discloses a generation support device that supports an operation of estimating man-hours or the like required for designing a project newly started (termed “new project”) on the basis of a history regarding projects carried out in the past. The generation support device includes an achievement data storage unit, an achievement data extraction unit, and a display unit. The achievement data storage unit can reserve a history regarding projects carried out in the past. The achievement data extraction unit converts a project into quantitative values, regarding items that are a kind of project, a customer participation rate, a degree of technological difficulty, productivity such as a degree of software commonality, and the like. The achievement data extraction unit extracts, as achievement data, a history regarding a project that is similar (or matches) in the converted value with regard to at least one item. The achievement data storage unit stores, as a history, the quantified data in accordance with the items as mentioned above with regard to each project carried out in the past.

Next, the achievement data extraction unit compares a value included in the extracted achievement data with a value input as estimate data. When the value included in the estimate data is smaller than the value included in the extracted achievement data, the achievement data extraction unit shows information indicating that the value included in the estimate data is smaller via the display unit.

The estimate data are generated, for example, at the time of a new project, on the basis of experience of a project manager and an instance in a project similar to the new project.

### CITATION LIST

### Patent Literature

PTL 1: Japanese Patent Application Laid-Open Publication No. 2008-102731

PTL 2: Japanese Patent Application Laid-Open Publication No. 2003-280901

### SUMMARY OF INVENTION

### Technical Problem

However, it is difficult to select a change history that serves as a basis for estimating man-hours or the like needed for a new project from among projects carried out in the past, on the basis of only the change history regarding the projects. A reason for this is that, although a change factor has relevancy to a value of man-hour and the like, the change history does not necessarily include a change factor. Further, a reason for this is that, even when the change history includes a change factor, the extent to which the change factor is relevant to development regarding the new project is unknown.

Therefore, a main object of the present invention is to provide an associated information generation device that facilitates estimation regarding a project, and the like.

### Solution to Problem

In order to achieve the aforementioned object, as an aspect of the present invention, an associated information generation device including:

associated information generation means for determining, on basis of project information including a task identifier that can uniquely identify a task included in a project, asset information in which the task identifier and a change factor representing a factor of changing a task identified by the task identifier are associated, and task information in which the change factor and a rate at which the change factor occurs are associated, the change factor associated with a specific task identifier included in the project information, determining the rate associated with the determined change factor, and generating associated information in which the determined rate and the specific task identifier are associated.

In addition, as another aspect of the present invention, an associated information generation method including:

determining, on basis of project information including a task identifier that can uniquely identify a task included in a project, asset information in which the task identifier and a change factor representing a factor of changing a task identified by the task identifier are associated, and task information in which the change factor and a rate at which the change factor occurs are associated, the change factor associated with a specific task identifier included in the project information, determining the rate associated with the determined change factor, and generating associated information in which the determined rate and the specific task identifier are associated.

Furthermore, the object is also realized by an associated information generation program, and a computer-readable recording medium which records the program.

### Advantageous Effects of Invention

The associated information generation device and the like according to the present invention facilitates estimation regarding a project.

### BRIEF DESCRIPTION OF DRAWINGS

FIG. 1 is a block diagram showing a configuration of an associated information generation device according to a first example embodiment of the present invention.

FIG. 2 is a flowchart showing a flow of a process in the associated information generation device according to the first example embodiment.

FIG. 3 is a diagram conceptually representing an example of task information.

FIG. 4 is a block diagram showing a configuration of an associated information generation device according to a second example embodiment of the present invention.

FIG. 5 is a flowchart showing a flow of a process in the associated information generation device according to the second example embodiment.

FIG. 6 is a diagram conceptually representing an example of a configuration included in the asset history information.

FIG. 7 is a diagram conceptually representing an example of associated information.

FIG. 8 is a diagram conceptually representing an example of project information.

FIG. 9 is a block diagram showing a configuration of an associated information generation device according to a third example embodiment of the present invention.

FIG. 10 is a flowchart showing a flow of a process in the associated information generation device according to the third example embodiment.

FIG. 11 is a diagram conceptually representing an example of adoption information.

FIG. 12 is a block diagram showing a configuration of an associated information generation device according to a fourth example embodiment of the present invention.

FIG. 13 is a flowchart showing a flow of a process in the associated information generation device according to the fourth example embodiment.

FIG. 14 is a diagram conceptually representing an example of exploitation information.

FIG. 15 is a diagram conceptually representing an example of conversion information.

FIG. 16 is a diagram conceptually representing an example of associated information generated by an associated information generation unit.

FIG. 17 is a block diagram schematically illustrating a hardware configuration of a calculation processing apparatus capable of realizing the associated information generation device according to each of example embodiments.

### DESCRIPTION OF EMBODIMENTS

Next, example embodiments that carry out the present invention will be described in detail with reference to the accompanying drawings.

### First Example Embodiment

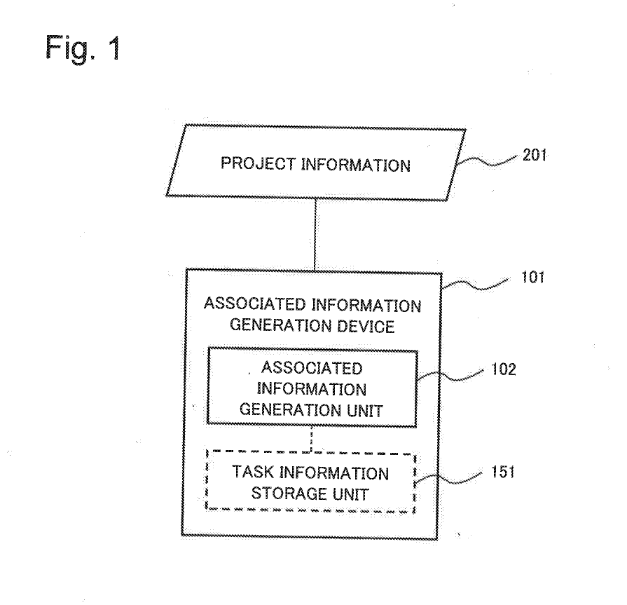

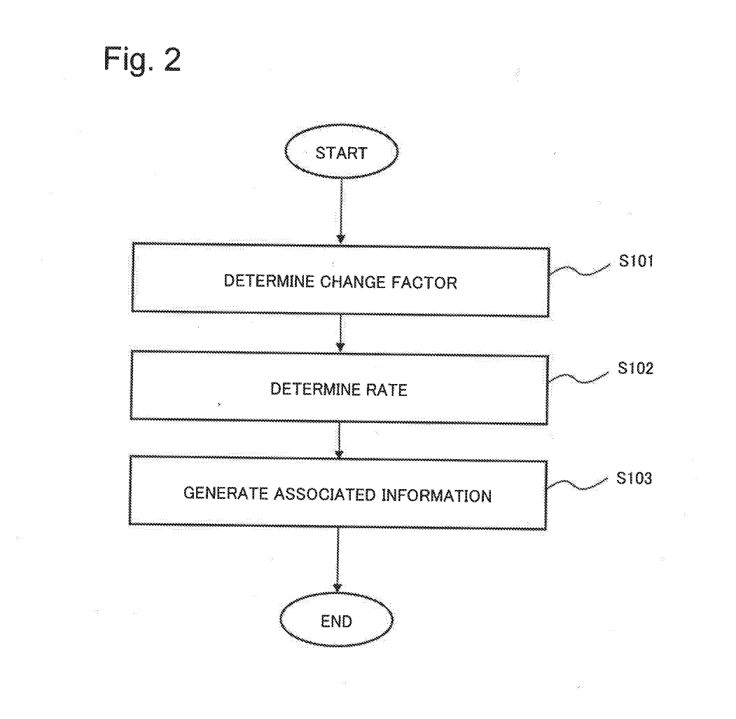

A configuration of an associated information generation device 101 according to a first example embodiment of the present invention and processes that the associated information generation device 101 performs will be described in detail with reference to FIG. 1 and FIG. 2. FIG. 1 is a block diagram showing a configuration of the associated information generation device 101 according to the first example embodiment of the present invention. FIG. 2 is a flowchart showing a flow of a process in the associated information generation device 101 according to the first example embodiment.

The associated information generation device 101 according to the first example embodiment includes an associated information generation unit 102.

The associated information generation device 101 may further include a task information storage unit 151. For convenience in description, it is assumed that a project is composed of a plurality of tasks.

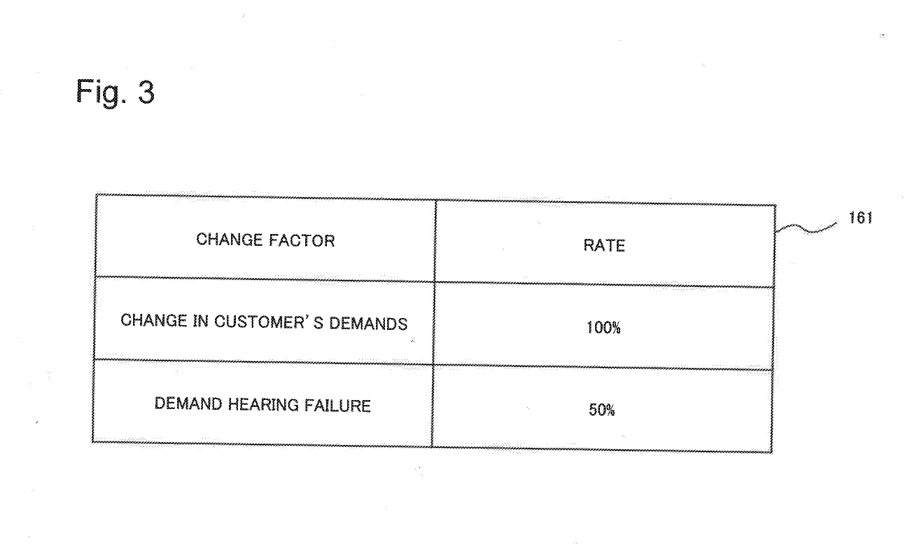

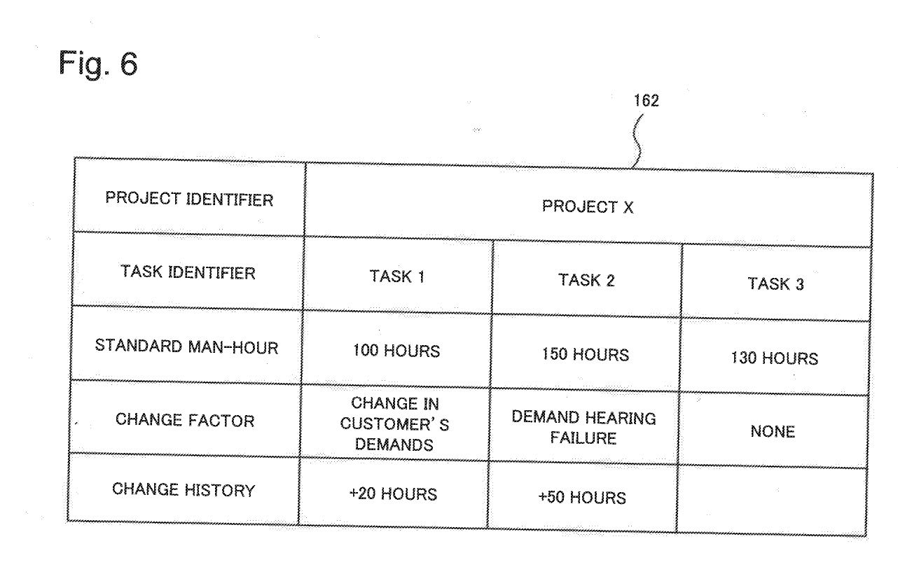

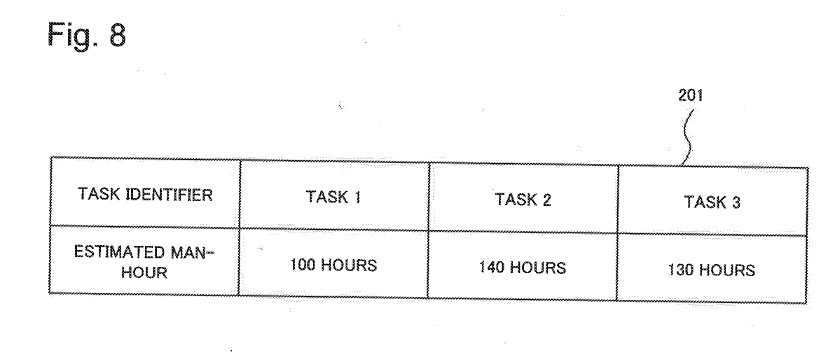

First, the associated information generation unit 102 receives project information 201 (exemplified in FIG. 8 and described later) including task identifiers that can identify tasks included in the project, for example. Next, the associated information generation unit 102 determines change factors associated individually with task identifiers included in the project information 201 on the basis of asset history information 162 (exemplified in FIG. 6, also termed “asset information” and described later) (step S101). Next, the associated information generation unit 102 determines a rate associated with the determined change factor on the basis of task information 161 (exemplified in FIG. 3 and described later) (step S102). Next, the associated information generation unit 102 generates associated information in which the rate determined with regard to the task identifier and the task identifier are associated (step S103).

Next, the project information 201 will be described with reference to FIG. 8. FIG. 8 is a diagram conceptually representing an example of the project information 201.

Referring to FIG. 8, with regard to a certain project, the project information 201 includes task identifiers that can identify tasks included in the certain project. Further, the project information 201 may be information in which the task identifiers and estimated man-hours regarding the tasks identified by the task identifier are associated.

For example, the project information 201 exemplified in FIG. 8 includes a task identifier “task 1”, a task identifier “task 2”, and a task identifier “task 3”. This represents that a certain project includes the task 1, the task 2, and the task 3. Further, in the project information 201, the task identifier “task 1” is associated with an estimated man-hour “100 hours”. This represents that the certain project includes the task 1 and that the estimated man-hour regarding the task 1 is 100 hours.

The project information 201 does not necessarily include an estimated man-hour associated with a project identifier and may further include an item of a standard man-hour or the like. That is, the project information 201 is not limited to the foregoing example.

In case of project information 201 exemplified in FIG. 8, the associated information generation unit 102 receives the project information 201 including at least a task identifier.

Next, the asset history information 162 will be described with reference to FIG. 6. FIG. 6 is a diagram conceptually representing an example of a configuration included in the asset history information 162.

The asset history information 162 includes a project information set in which a project identifier that can identify a project is associated with task identifiers identifying tasks included in the project. Each task identifier in the project information set may be associated with a detailed task information set including a standard man-hour indicating a standard man-hour needed for the task identified by the task identifier, a change factor representing a factor of a change that occurs regarding the task, and a change history that represents a required time needed for the change if the change occurs.

For example, the asset history information 162 exemplified in FIG. 6 includes a project information set in which a project identifier “project X”, a task identifier “task 1”, a task identifier “task 2”, and a task identifier “task 3” are associated. This represents that the project X is composed of the task 1, the task 2, and the task 3. Incidentally, the asset history information 162 may include a plurality of project information sets.

Further, the task identifier “task 1” is associated with a detailed task information set including a standard man-hour “100 hours”, a change factor “change in the customer's demands”, and a change history “+20 hours”. This represents that the standard man-hour regarding the task 1 is 100 hours, and that the change factor for changing the task 1 is a “change in the customer's demands”, and that the required time for changing the task 1 is “+20 hours”.

The required time “+20 hours” represents that the required time needed for the change increases by 20 hours when a change due to a change factor “change in the customer's demands” regarding the task 1 occurs. Further, in the detailed task information set associated with the task identifier “task 1”, the standard man-hour of 100 hours is, for example, a time that includes the required time needed for a change resulting from the change factor regarding the task 1. That is, the standard man-hour regarding the task 1 is 80 hours (=100 hours−(+20 hours)) when the change resulting from the change factor does not occur.

The detailed task information set associated with the task identifier “task 2” includes substantially a configuration similar to the detailed task information set associated with the task identifier “task 1”. Therefore, description of the detailed task information set will be omitted. Further, the detailed task information set associated with the task identifier “task 3” includes “none” for the change factor and a change history “ ” (i.e., a blank). This represents that there is no change factor regarding the task 3.

That is, in the asset history information 162 exemplified in FIG. 6, the task 1, the task 2, and the task 3 are tasks included in one project X.

The asset history information 162, for example, includes a project information set in which the project identifier for the project is associated with the unique task identifiers of the tasks included in the project regarding a project carried out in the past. Further, each task identifier may be associated with a detailed task information set including information such as the standard man-hour regarding the task, the change factor regarding the task, and the change history regarding the task.

In the process shown by step S101, the associated information generation unit 102 determines the change factors associated with the task identifiers included in the project information 201 in the asset history information 162 exemplified in FIG. 6. In the asset history information 162 exemplified in FIG. 6, the project identifier, the task identifiers, and the change factors are associated.

Next, the task information 161 will be described with reference to FIG. 3. FIG. 3 is a diagram conceptually representing an example of the task information 161. Incidentally, the task information storage unit 151 can store the task information 161.

The task information 161 exemplified in FIG. 3 is information in which a change factor regarding a task and an occurrence rate of the change factor are associated. In other word, the task information 161 is information in which a change factor that occurs regarding a task included in the project and the probability that the change factor will occur (arise or recur) are associated in the case where a plan regarding a project is generated or the case where the generated plan is executed. The task information storage unit 151 can store the foregoing task information 161.

For example, in the task information 161 exemplified in FIG. 3, the change factor “change in the customer's demands” and the rate “100%” are associated. This represents that, with regard to a certain task, the occurrence rate of the change factor “change in the customer's demands” is “100%”. Further, in the task information 161, a change factor “demand hearing failure” and a rate “50%” are associated. This represents that the occurrence rate of the change factor “demand hearing failure” with regard to a certain task is “50%”.

The task information 161 may be information in which the change factor for a task, the name of the task, and the task identifier for the task are associated. That is, the task information 161 is not limited to the foregoing examples.

That is, in the process shown in step S102, the associated information generation unit 102 determines a rate (probability) associated with an identified change factor on the basis of the task information 161 exemplified in FIG. 3.

When task information 161 is stored in the task information storage unit 151, the associated information generation unit 102 may determine a change factor and a rate on the basis of the task information 161 stored in the task information storage unit 151 in the process shown in step S102.

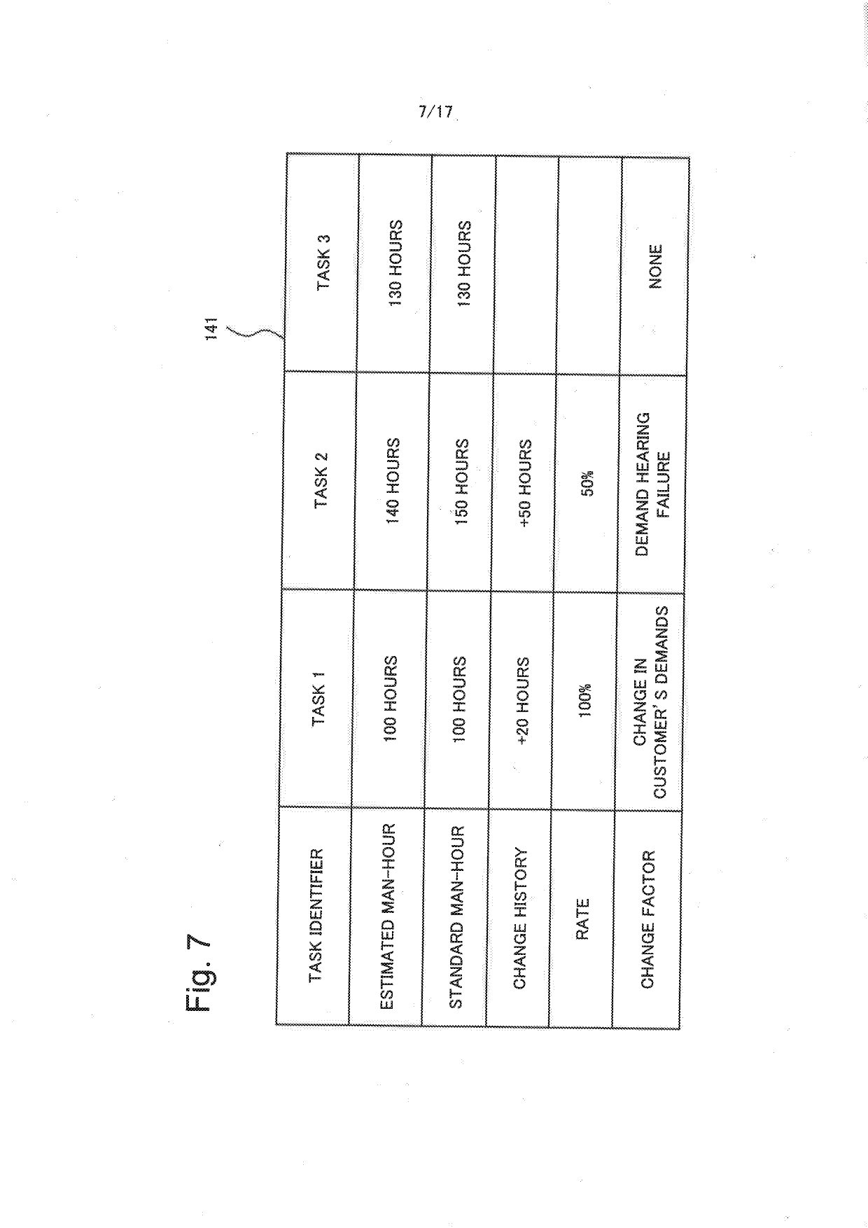

As have been described with reference to FIG. 2, the associated information generation unit 102 generates associated information in which the task identifier of a task included in the project information 201 and a rate determined with regard to the task identifier are associated in the process shown in step S103. An example of the associated information is exemplified in FIG. 7 described later. Detailed description of the associated information is omitted herein.

Next, advantageous effects of the associated information generation device 101 according to the first example embodiment will be described.

According to the associated information generation device 101, estimation regarding a project are facilitated.

A reason for this is because the associated information generation device 101 determines an occurrence rate of a change factor and generates associated information in which the determined rate and the task identifier are associated, on the basis of the task information 161 exemplified in FIG. 3 with regard to each task identifier included in the project information 201.

For example, a manager concerned with a project estimates a man-hour needed to change the certain task on the basis of the change factor regarding a certain task included in the project. Next, the manager can easily estimate a man-hour needed for the entire project by using the rate calculated by the associated information generation device 101 as a weight regarding the task.

On the other hand, according to the devices disclosed in PTL 1 and PTL 2, a man-hour regarding the project cannot be easily estimated on the basis of a change factor regarding a task included in the project. This is because the device cannot calculate an occurrence rate of the change factor. In other word, the manager can estimate the man-hour needed for a task change (i.e., that a change factor gives rise to) but, on the other hand, cannot calculate an occurrence rate of the change factor. As a result, the manager cannot easily estimate a man-hour regarding the project.

### Second Example Embodiment

Next, a second example embodiment of the present invention based on the foregoing first example embodiment will be described.

In the following description, characteristic portions according to the present example embodiment will be centrally described while substantially the same configurations as those in the foregoing first example embodiment are given the same reference numbers and redundant description will be omitted.

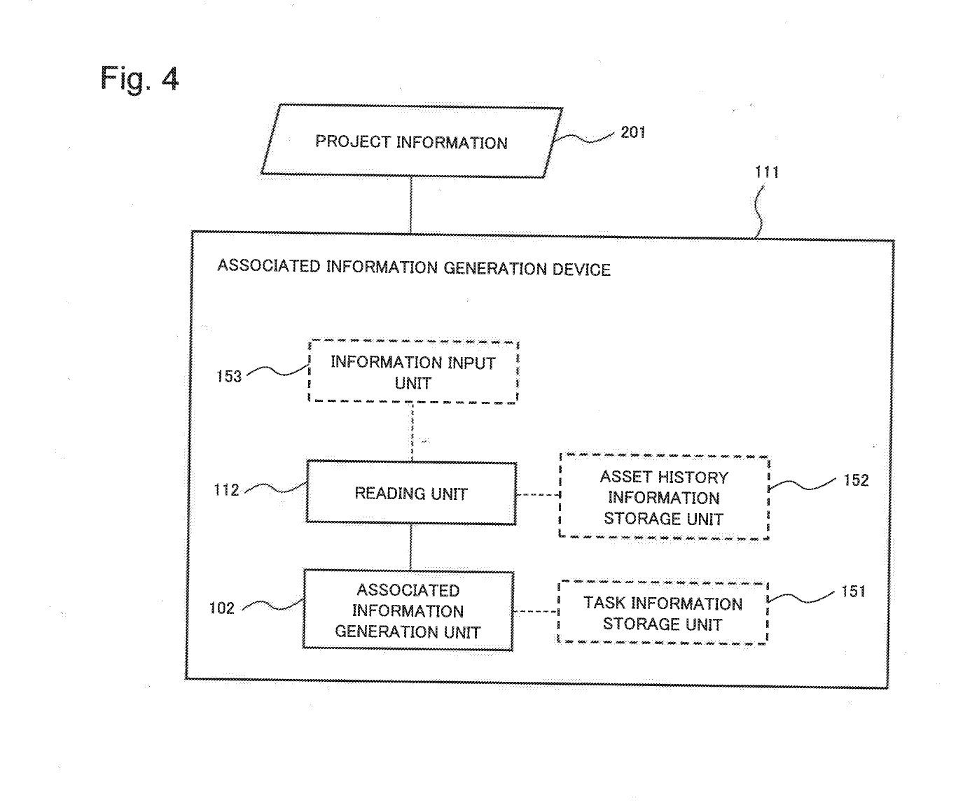

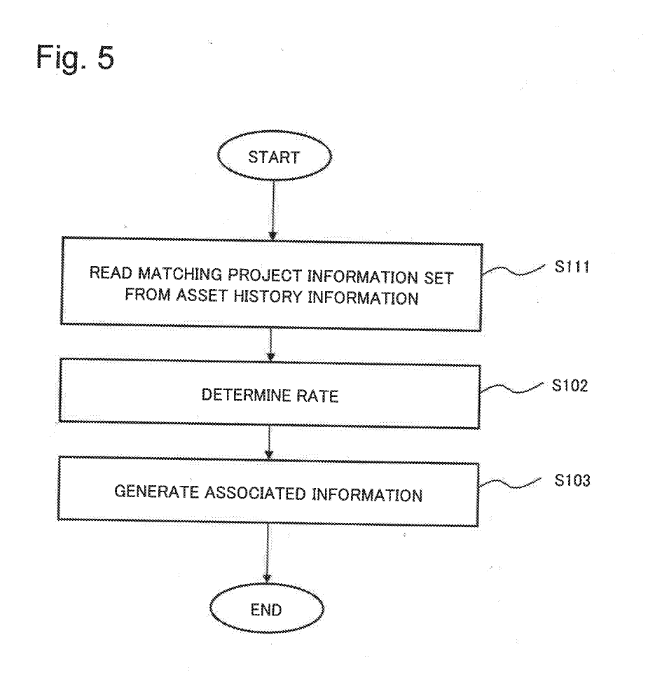

With reference to FIG. 4 and FIG. 5, a configuration of an associated information generation device 111 according to the second example embodiment and a process performed by the associated information generation device 111 will be described. FIG. 4 is a block diagram showing a configuration of the associated information generation device 111 according to the second example embodiment of the present invention. FIG. 5 is a flowchart showing a flow of a process in the associated information generation device 111 according to the second example embodiment.

The associated information generation device 111 according to the second example embodiment includes a reading unit 112 and an associated information generation unit 102.

The associated information generation device 111 may further include a task information storage unit 151, an asset history information storage unit 152, and an information input unit 153.

First, the information input unit 153 receives project information 201 exemplified in FIG. 8 via the information input unit 153.

The project information 201 does not need to be information regarding a new project but may also be about, for example, a project that has been carried out and that is similar to (or matches) a new project.

Next, the reading unit 112 determines a project information set regarding a project including tasks that are the same as the tasks included in the project information 201 in the asset history information 162 (described later with reference to FIG. 6) stored in the asset history information storage unit 152.

Now, with reference to FIG. 6, the asset history information 162 that can be stored in the asset history information storage unit 152 will be described.

The reading unit 112 determines a project information set that includes task identifiers matching the task identifiers in the project information 201 among the project information sets included in the asset history information 162 (step S111). Further, regarding each task identifier included in the determined project information set, the reading unit 112 may read a detailed task information set associated with the task identifier. The reading unit 112 sends the determined project information set to the associated information generation unit 102.

The associated information generation unit 102 receives the project information set determined by the reading unit 112. The associated information generation unit 102 reads change factors for each task identifier from the detailed task information sets associated to the task identifiers included in the received project information set. Next, the associated information generation unit 102 determines rates associated with each of the read change factors in the task information 161 (step S102).

With regard to each task identifier included in the received project information set, the associated information generation unit 102 generates information (FIG. 7) that represents a detailed task information set including the rate determined in step S102 on the basis of the change factor included in the detailed task information set associated with that task identifier (step S103). For convenience in description, the generated information is termed “associated information”.

With reference to FIG. 7, the associated information will be described. FIG. 7 is a diagram conceptually representing an example of associated information 141. As exemplified in FIG. 7, the associated information 141 includes project information sets regarding a specific project in the asset history information 162. Further, each task identifier included in the project information set is associated with a detailed task information set as described above. Here, with regard to the project information set and the detailed task information sets, redundant descriptions will be omitted.

In the associated information 141 exemplified in FIG. 7, the detailed task information set associated with the task 1 includes a rate “100%”. This represents that the associated information 141 is has been generated by appending the rate “100%” determined based on a change factor “change in the customer's demands” to the detailed task information set associated with the task 1 regarding the change factor through the associated information generation unit 102.

Further, in the associated information 141 exemplified in FIG. 7, the detailed task information set associated with the task 1 includes 100 hours (a section “estimated man-hour”). That is, this represents that the task 1 is associated with the estimated man-hour of 100 hours.

Description of the detailed task information set associated with the task 2 is substantially similar to the description of the detailed task information set associated with the task 1 and therefore will be omitted. The foregoing estimated man-hour is a time that includes a required time needed when a change factor occurs.

As described above in the first example embodiment, the task 1 in the project information 201 is associated with 100 hours in the project information 201 exemplified in FIG. 8. This represents that the estimated man-hour needed for the task identified by the task 1 is 100 hours. Further, the task 2 in the project information 201 is associated with 140 hours. This represents that the estimated man-hour needed for the task identified by the task 2 is 140 hours.

The associated information generation unit 102 may display the generated associated information 141 in a display unit (not graphically shown). In other word, the display unit displays the associated information 141 in which the rate determined by the associated information generation unit 102 and the estimated man-hour and the like regarding that task are associated with regard to each task included in the project information 201. As described above, in the associated information 141 exemplified in FIG. 7, pieces of information regarding a task are mutually associated, so that it is easy for a user to conceptually understand a project on the basis of the associated information 141.

A user of the associated information generation device 111 can, for example, determine whether or not the estimated man-hour regarding a new project is correct on the basis of the associated information 141 displayed in the display unit.

Next, advantageous effects of the associated information generation device 111 according to the second example embodiment will be described.

The associated information generation device 111 according to the present example embodiment has advantageous effects of the associated information generation device 101 according to the first example embodiment and, furthermore, an advantageous effect of it becoming easy for a user to consider a project.

Reasons for this are a reason 1 and a reason 2. They are:

(reason 1) because the configuration of the associated information generation device 111 according to the second example embodiment includes a configuration of the associated information generation device 101 according to the first example embodiment; and

(reason 2) because the associated information generation unit 102 generates, for example, the associated information 141 in which information read from the task information 161 and the task identified by a task identifier included in the project information 201 are associated, as described above.

As described above, the user can, for example, determine whether or not the estimated man-hour included in the project information 201 is correct based on the associated information 141 exemplified in FIG. 7. Specifically, because the associated information 141 is information in which the project information 201 and information read from the task information 161 are associated, the user can compare the change history regarding a task and the rate (e.g., probability of recurrence) in the associated information 141. Therefore, the user can easily consider the project.

### Third Example Embodiment

Next, a third example embodiment of the present invention based on the foregoing second example embodiment will be described.

In the following description, characteristic portions according to the present example embodiment will be centrally described while substantially the same configurations as those in the foregoing second example embodiment are given the same reference numbers and redundant description will be omitted.

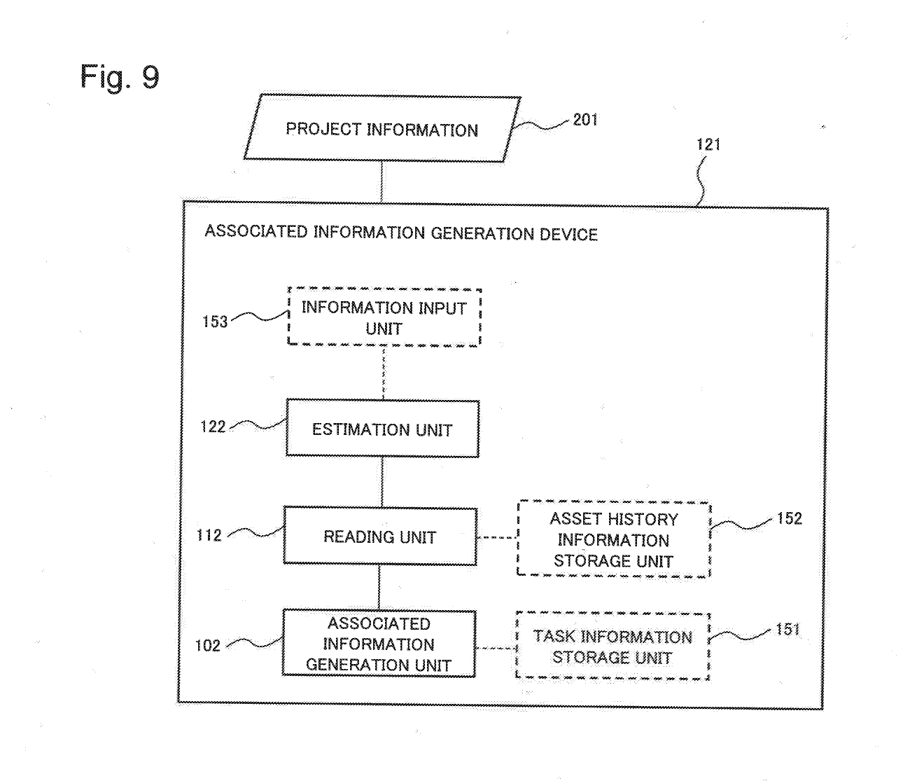

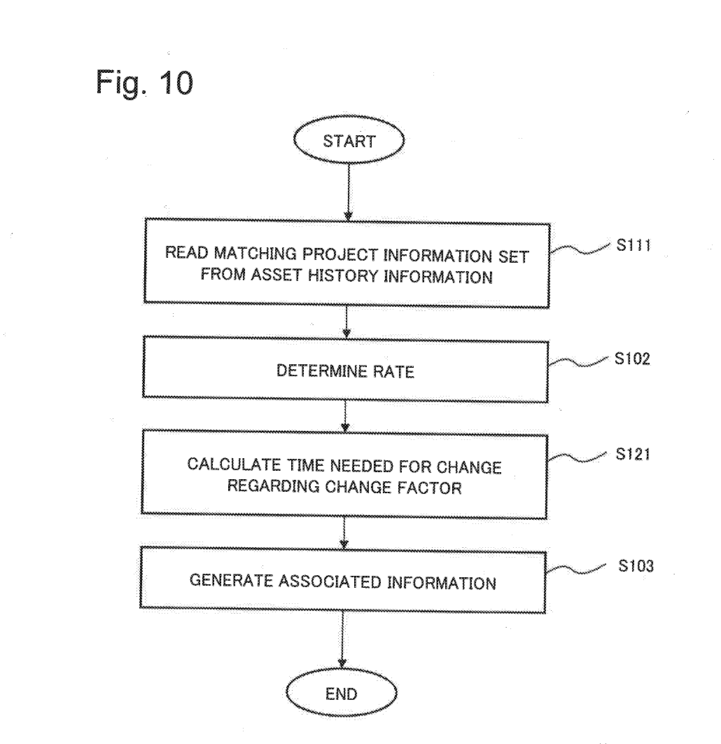

With reference to FIG. 9 and FIG. 10, a configuration of an associated information generation device 121 according to the third example embodiment and a process performed by the associated information generation device 121 will be described. FIG. 9 is a block diagram showing a configuration of the associated information generation device 121 according to the third example embodiment of the present invention. FIG. 10 is a flowchart showing a flow of a process in the associated information generation device 121 according to the third example embodiment.

The associated information generation device 121 according to the third example embodiment includes a reading unit 112, an associated information generation unit 102, and an estimation unit 122.

The associated information generation device 121 may further include a task information storage unit 151, an asset history information storage unit 152, and an information input unit 153.

Similarly to the second example embodiment, the associated information generation unit 102 determines rates by executing the process shown in step S111 and step S102. Next, the estimation unit 122 calculates, on the basis of each rate determined by the associated information generation unit 102, a time (hereinafter, termed “first time”) needed for a change resulting from a change factor regarding a task included in the project information 201, for example, in accordance with Eqn. 1 to Eqn. 3 described later (step S121).

In the following description, for convenience in description, it is assumed that the detailed task information set includes a change history as exemplified in FIG. 7. In this case, with regard to each task identifier included in the associated information 141, the estimation unit 122 may execute the process shown in step S121 on the basis of a change history included in a detailed task information set associated with the task identifier.

In step S121, the estimation unit 122 reads the change history and the rate, that are included in the detailed task information set associated with a task identifier, with regard to each of the task identifiers from the associated information 141. Next, the estimation unit 122 estimates a first time on the basis of the read change history and the read rate. In this case, for example, the estimation unit 122 calculates the first time according to Eqn. 1.

(First time)=(estimated man-hour)−(change history)+(change history)×(rate) (Eqn. 1)

(where the project information 201 includes the estimated man-hour).

That is, according to Eqn. 1, two values, that is an expected value (=(change history)×(rate)) of the time needed for the change resulting from the change factor and a required time needed in the case not resulting from the change factor, are added. The first time represents an expected value of the required time needed for the task identified by the task identifier. The estimation unit 122 may calculate the first time by calculating the value according to a predetermined function for calculating a value by using a change history and a rate as inputs. That is, the procedure for calculating the first time through the estimation unit 122 is not limited to the foregoing examples.

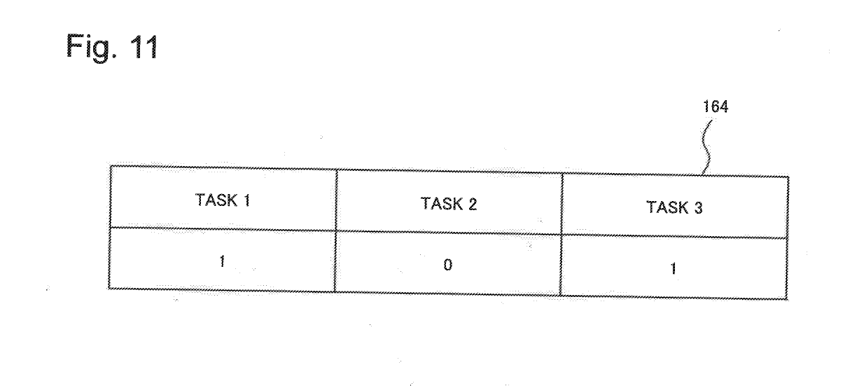

Further, the estimation unit 122 may calculate the first time according to adoption information 164 exemplified in FIG. 11. FIG. 11 is a diagram conceptually representing an example of the adoption information 164.

The adoption information 164 is information in which each task identifier is associated with characteristic information representing whether or not to adopt, with regard to the task identified by the task identifier, a calculation procedure (e.g., Eqn. 1, and the following Eqn. 2 or Eqn. 3) of calculating the first time on the basis of the rate determined in step S102. In the adoption information 164 exemplified in FIG. 11, the characteristic information “1” represents that the calculation procedure for the first time on the basis of the rate determined in step S102 is adopted, and the characteristic information “0” represents that the calculation procedure is not adopted. For example, in the adoption information 164, the task identifier “task 1” is associated with the characteristic information “1”. This represents that, in the case of calculating the first time, the procedure for calculating the first time on the basis of the rate determined in step S102 is adopted with regard to the task 1. Therefore, the adoption information 164 exemplified in FIG. 11 represents that, in the case of calculating the first time, the calculation procedure is adopted with regard to the task 1 and the task 3 and the calculation procedure is not adopted with regard to the task 2.

That is, the estimation unit 122 determines the characteristic information associated with a task identifier included in the project information 201 in the adoption information 164, and estimates the first time according to the characteristic information. For example, the estimation unit 122 estimates the first time according to the calculation procedure exemplified by Eqn. 1 or the like, with regard to the task 1 included in the project information 201. Because the task 2 is associated with 0, the estimation unit 122 does not adopt the calculation procedure but estimates the change history as the first time. Because the task 3 is associated with “1”, the estimation unit 122 estimates the first time according to the calculation procedure exemplified in Eqn. 1 or the like with regard to the task 3.

Further, in the case where the adoption information 164 includes a task identifier and a new rate regarding the task identified by the task identifier, the estimation unit 122 may estimate the first time on the basis of the new rate.

For example, the user generates the adoption information 164 exemplified in FIG. 11 on the basis of the associated information 141 displayed in the display unit. In other word, the user determines whether or not the rate determined in step S102 is applicable to the project information 201 on the basis of the associated information 141. If the user determines that the determined rate cannot be applied, the user adds a new rate to the adoption information 164.

The associated information generation unit 102 generates, as new associated information 141, information in which a task in the associated information 141 and the first time calculated regarding the task by the estimation unit 122 are associated with regard to each task included in the associated information 141 (step S103). In the associated information 141 exemplified in FIG. 7, each value shown in the “standard man-hour” section is associated, as the first time, with the task identifier (“task 1”, “task 2”, . . . ) of the task. Further, the associated information generation unit 102 may display the calculated associated information 141 in the display unit (not graphically shown).

Next, advantageous effects of the associated information generation device 121 according to the third example embodiment will be described. The associated information generation device 121 according to the present example embodiment has the advantageous effects of the associated information generation device 111 according to the second example embodiment and, furthermore, an advantageous effect that the information calculated regarding a project is more accurate.

Reasons for this are a reason 1 and a reason 2. They are:

(reason 1) because the configuration of the associated information generation device 121 according to the third example embodiment includes the configuration of the associated information generation device 111 according to the second example embodiment; and

(reason 2) because the estimation unit 122 estimates the first time on the basis of the rate and the change history.

Therefore, the user can understand a project in more detail on the basis of the associated information 141 including the first time (i.e., the value shown in the “standard man-hour” section).

### Fourth Example Embodiment

Next, a fourth example embodiment of the present invention based on the foregoing third example embodiment will be described.

In the following description, characteristic portions according to the present example embodiment will be centrally described while substantially the same configurations as those in the foregoing third example embodiment are given the same reference numbers and redundant description will be omitted.

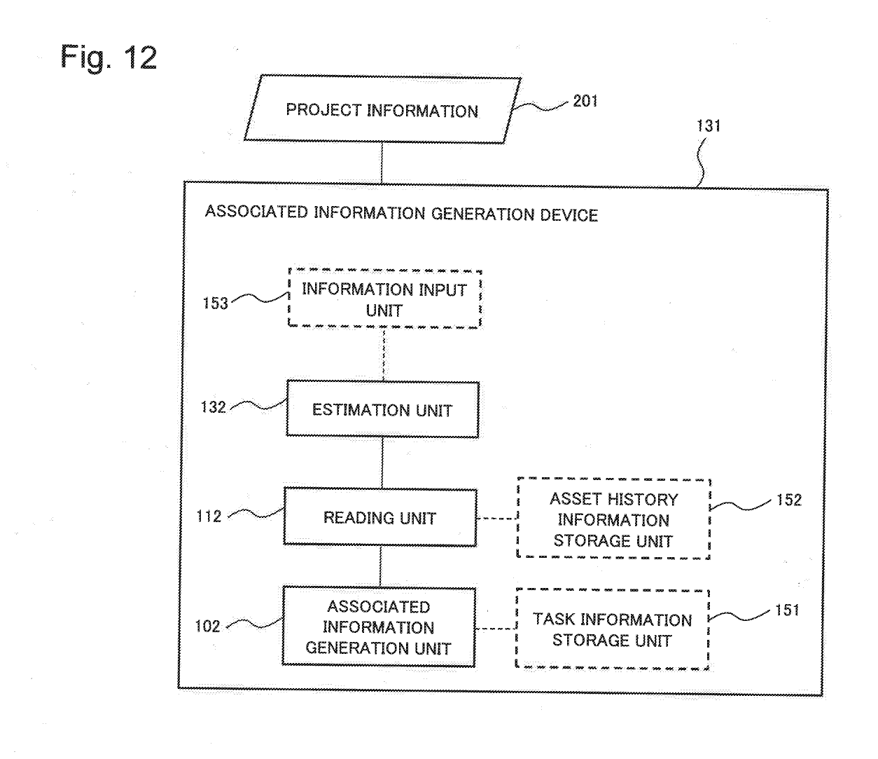

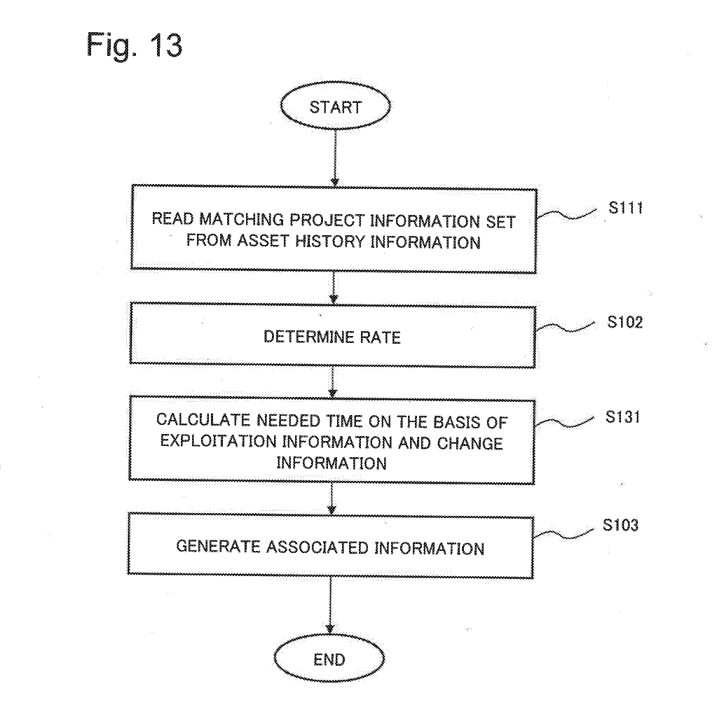

With reference to FIG. 12 and FIG. 13, a configuration of an associated information generation device 131 according to the fourth example embodiment and a process performed by the associated information generation device 131 will be described. FIG. 12 is a block diagram showing a configuration of the associated information generation device 131 according to the fourth example embodiment of the present invention. FIG. 13 is a flowchart showing a flow of a process in the associated information generation device 131 according to the fourth example embodiment.

The associated information generation device 131 according to the fourth example embodiment includes a reading unit 112, an associated information generation unit 102, and an estimation unit 132.

The associated information generation device 131 may further include a task information storage unit 151, an asset history information storage unit 152, and an information input unit 153.

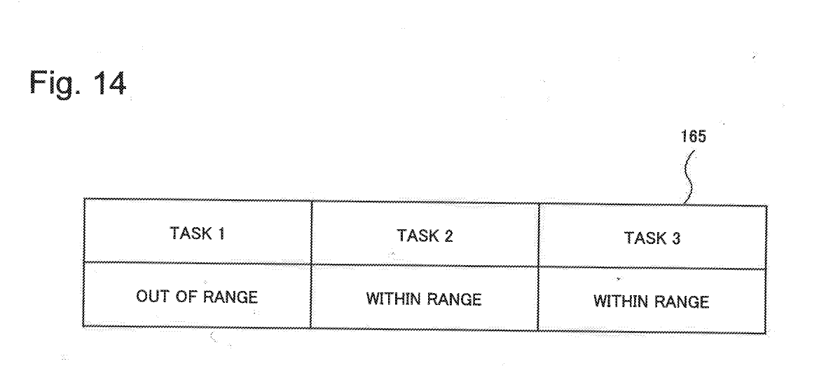

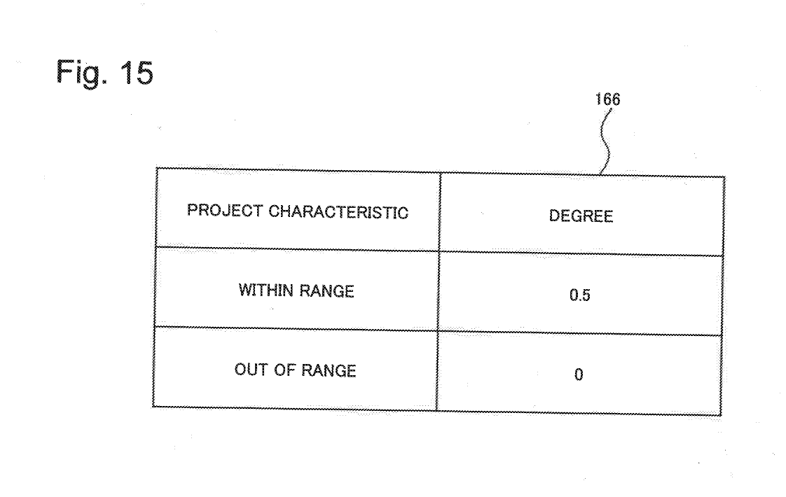

Similarly to the second example embodiment and the third example embodiment described above, as step S111 and step S102 are executed, the associated information generation unit 102 determines a rate. The estimation unit 132 estimates a first time needed to solve a factor regarding a task included in project information 201 on the basis of the rate determined by the associated information generation unit 102, exploitation information 165 (exemplified in FIG. 14 and described later), and conversion information 166 (exemplified in FIG. 15 and described later) (step S131). FIG. 14 is a diagram conceptually representing an example of the exploitation information 165. FIG. 15 is a diagram conceptually representing an example of the conversion information 166.

In the exploitation information 165 exemplified in FIG. 14, a characteristic, that is representing whether or not a task in a project included in the asset history information 162 exemplified in FIG. 6 affects a new project (hereinafter, termed “project characteristic”), and a task identifier, that can identify the task, are associated. For example, in the exploitation information 165 exemplified in FIG. 14, a task identifier “task 1” is associated with a project characteristic “out of range”. This represents that in the case where the man-hour or the like regarding a new project is estimated, the task 1 in the project included in the asset history information 162 is not referred to. A task identifier “task 2” is associated with a project characteristic “within range”. A task identifier “task 3” is associated with the project characteristic “within range”. This represents that in the case where the man-hour or the like regarding the new project is estimated, the task 1 and the task 2 in the project included in the asset history information 162 are referred to.

Further, in the conversion information 166 exemplified in FIG. 15, a project characteristic and a degree in the case where the project characteristic is converted are associated. In the conversion information 166 exemplified in FIG. 15, the project characteristic “out of range” and a degree “0” are associated. This represents that, in the case where the project characteristic is “out of range”, the project characteristic is converted to the degree of 0. Further, in the conversion information 166 exemplified in FIG. 15, the project characteristic “within range” and a degree “0.5” are associated. This represents that, in the case where the project characteristic is “within range”, the project characteristic is converted to the degree of 0.5.

The degree may be a negative number. In the case where the degree is a negative number, the estimation unit 132 calculates the first time in accordance with Eqn. 3.

Incidentally, the exploitation information 165 exemplified in FIG. 14 is information regarding the project information 201 exemplified in FIG. 8. Therefore, the tasks in the exploitation information 165 or the tasks in the project characteristic include the tasks in the project information 201.

The estimation unit 132 determines the project characteristic associated with a certain task identifier on the basis of the exploitation information 165 (step S131). The estimation unit 132 determines the degree associated with the determined project characteristic on the basis of the conversion information 166 exemplified in FIG. 15. Next, the estimation unit 132 reads the estimated man-hour associated with a task identifier identifying a task included in the project information 201 exemplified in FIG. 8. Next, the estimation unit 132 calculates the first time on the basis of a rate calculated by the associated information generation unit 102 and the change history associated with the task.

In the case where the determined degree is greater than or equal to 0, the estimation unit 132 calculates the first time regarding the task in the project information 201, for example, in accordance with Eqn. 2.

(First time)=(estimated man-hour)−(change history)+(change history)×(rate)×(degree) (Eqn. 2)

Further, in the case where the read degree is negative, the estimation unit 132 calculates the first time regarding the task in the project information 201, for example, according to Eqn. 3.

(First time)=(estimated man-hour)−(change history)+(change history)×(rate)×(1−(degree)) (Eqn. 3)

For example, in the conversion information 166 exemplified in FIG. 15, the value of a project characteristic and the degree are determined based on the extent to which assets are re-used in the project, the degree to which participants in the project are skilled regarding the project, or the like. The value indicated by (estimated man-hour−change history) in Eqn. 1 to Eqn. 3 represents the standard man-hour in the case where a change factor does not occur.

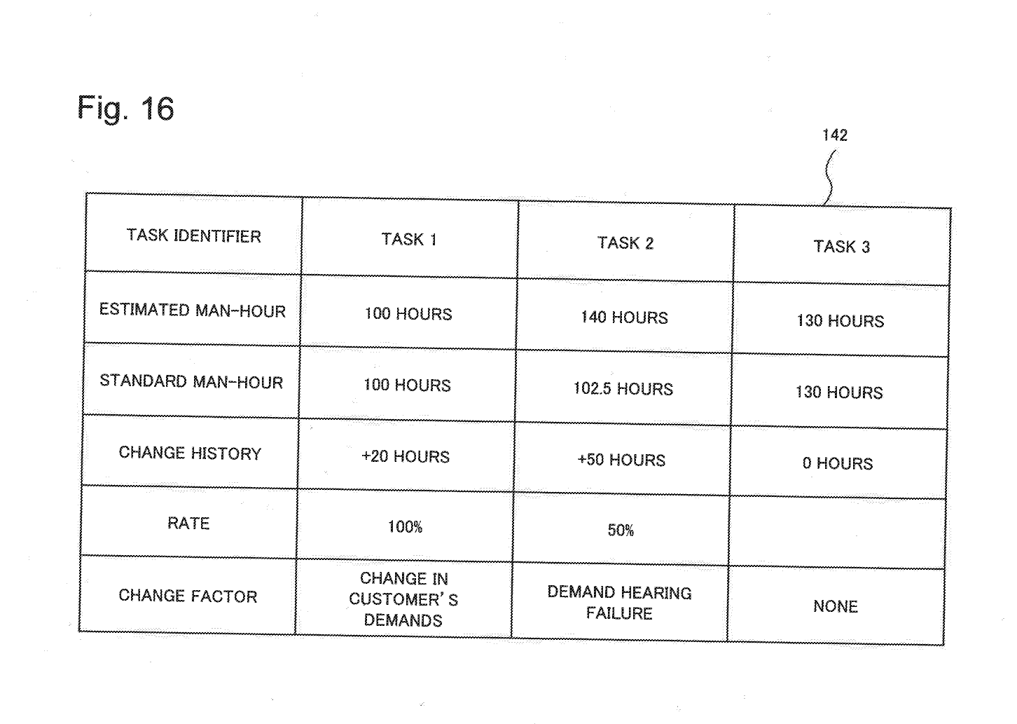

Next, similarly to the process in the associated information generation device 121 according to the third example embodiment, the associated information generation unit 102 generates information in which the first time and a task are associated, and calculates the generated information as the associated information 142 regarding the project (step S103). FIG. 16 is a diagram conceptually representing an example of the associated information 142 generated by the associated information generation unit 102. In the associated information 142 exemplified in FIG. 16, each value indicated in the “standard man-hour” section is associated, as the first time, with the task identifier (“task 1”, “task 2”, . . . ) identifying the task.

Incidentally, a configuration of the associated information 142 shown in FIG. 16 includes a configuration similar to the configuration of the information shown in FIG. 7 and, therefore, descriptions regarding the configuration of the associated information 142 generated by the estimation unit 132 will be omitted herein.

Further, in the foregoing description, the estimation unit 132 reads the degrees associated with the values of characteristic information in the adoption information 164 from the conversion information 166. For example, the estimation unit 132 may read the degrees on the basis of the information in which the task and the degrees are associated.

Next, a process in the associated information generation device according to each of the foregoing example embodiments will be described by using examples. Hereinafter, description will be made by using the signs used in the fourth example embodiment. However, the following description is not limited to the associated information generation device 131 according to the fourth example embodiment.

The associated information generation device 131 receives the project information 201 exemplified in FIG. 8.

For example, a user, who makes a plan regarding a new project, generates project information 201 in which a task identifier and an estimated man-hour regarding the task identified by the task identifier are associated. In the case where the estimated man-hour cannot be estimated, the user may set the estimated man-hour as a blank. Further, in the case where the estimated man-hour is set as a blank, the associated information generation device 131 may set the estimated man-hour on the basis of information included in the asset history information 162. The user inputs the generated project information 201 to the associated information generation device 131.

It is assumed that, for example, the asset history information 162 exemplified in FIG. 6 is stored in the asset history information storage unit 152. The asset history information 162 exemplified in FIG. 6 includes information regarding a project (e.g., “project X”). In the case where the associated information generation device 131 calculates the associated information 142 regarding the project, the asset history information 162 can be repeatedly used.

The project X included in the asset history information 162 exemplified in FIG. 6 includes the task 1, the task 2, and the task 3.

Referring to the column indicated by the task 1 in the asset history information 162 exemplified in FIG. 6, the standard man-hour regarding the task 1 is 100 hours. Further, the time indicated by the standard man-hour regarding the task 1 includes the time of execution of a change on the task 1. Furthermore, in the asset history information 162 exemplified in FIG. 6, the change factor regarding the change is a “change in the customer's demands”. Furthermore, the standard man-hour regarding the task 1, as having been described with reference to FIG. 6, is 80 (=100−20) hours before the change factor occurs, and the standard man-hour added by the change in the customer's demands is “+20 hours”.

For example, the user sets task information 161 exemplified in FIG. 3, beforehand.

With regard to the task included in the project X, the associated information generation unit 102 reads the change history associated with the task.

For convenience in description, it is assumed that the associated information generation unit 102 reads the task 2 included in the project X.

In the asset history information 162 exemplified in FIG. 6, the task 2 is associated with “demand hearing failure”. The associated information generation unit 102 determines the rate associated with the “demand hearing failure” based on the task information 161 exemplified in FIG. 3. For example, the associated information generation unit 102 determines the rate “50%” associated with the “demand hearing failure” in the task information 161.

Next, the associated information generation unit 102 generates associated information (exemplified in FIG. 7 or FIG. 16) in which tasks, rates, change histories, etc., are associated with one another by following the foregoing process and displays the generated associated information on a display unit (not graphically shown).

At this time, a user can make a plan by determining whether or not to adopt a change history or whether or not to adopt an estimated man-hour on the basis of the associated information generated by the associated information generation unit 102 and displayed on the display unit. The user may change the rates. The process in this case is similar to a process performed in the case where the reading of the rate is switched to a value obtained after the rate is changed.

Next, on the basis of the project characteristic, the process procedure of calculating the first time will be described.

As described above, the exploitation information 165 exemplified in FIG. 14 is information in which a task identifier is associated with a project characteristic that represents whether or not the task identified by the task identifier affects the project. The exploitation information 165 includes information regarding one or more tasks. The exploitation information 165 exemplified in FIG. 14 includes three task identifiers that are a task 1, a task 2, and a task 3. The task identifiers are associated with project characteristics. For example, the task 1 is associated with a project characteristic “out of range”. This represents that, with regard to the task 1, the project information set included in the asset history information 162 is not referred to. Further, in the exploitation information 165, the task 2 and the task 3 are associated with a project characteristic “within range”. This represents that, with regard to the task 2 and the task 3, the project information set included in the asset history information 162 is referred to.

The user generates exploitation information 165 in which task identifiers are associated with the project characteristics regarding the tasks identified by the task identifiers, and inputs the generated exploitation information 165 to the associated information generation device 131.

The conversion information 166 exemplified in FIG. 15 is information in which project characteristics and degrees are associated. For example, in the conversion information 166, the project characteristic “out of range” and a degree “0” are associated. Further, in the conversion information 166, the project characteristic “within range” and a degree “0.5” are associated. These represent that, when the project characteristic is the “within range”, the degree is set to 0.5 and that, when the project characteristic is the “out of range”, the degree is set to 0. For example, when the rate is increased, the degree may be a negative number. For example, when the degree is “−0.2”, the estimation unit 132 adds 0.2 to the rate.

Next, since the characteristic information associated with the task 2 is set to the “within range”, the estimation unit 132 sets the degree to 0.5 (=50%). Next, the estimation unit 132 calculates a suggestion man-hour with regard to the task according to Eqn. 2. For example, the estimation unit 132 calculates the first time regarding the task 2 as being 102.5 hours (=140 hours−50 hours+50 hours×0.5×0.5) in accordance with the calculation procedure exemplified in Eqn. 2. In other word, the estimation unit 132 estimates the first time (suggestion man-hour) regarding the task 2 on the basis of four values, that is, the standard man-hour (=140 hours−50 hours) that does not include a change factor, the required time (=50 hours) regarding the change factor, a rate (=0.5), and a degree (=0.5).

When the degree is negative, the estimation unit 132 calculates the suggestion man-hour regarding the task in accordance with the calculation procedure exemplified in Eqn. 3.

The associated information generation device 131 generates information exemplified in FIG. 16 by executing the foregoing process. In the information exemplified in FIG. 16, the task 2 is associated with the calculated 102.5 hours.

Next, advantageous effects of the associated information generation device 131 according to the fourth example embodiment will be described. The associated information generation device 131 according to the present example embodiment has the advantageous effects of the associated information generation device 121 according to the third example embodiment and, furthermore, an advantageous effect of being capable of calculating appropriate man-hours.

Reasons for this are a reason 1 and a reason 2. They are:

(reason 1) because the configuration of the associated information generation device 131 according to the fourth example embodiment includes the configuration of the associated information generation device 121 according to the third example embodiment; and

(reason 2) because the estimation unit 132 further calculates the first time on the basis of the exploitation information 165 regarding the project and the conversion information 166.

That is, because the calculation procedure is based on the conversion information 166 and the exploitation information 165 regarding the project, the first time calculated by the estimation unit 132 is more accurate than the first time calculated by the estimation unit 122.

(Hardware Configuration Example)

A configuration example of hardware resources that realize an associated information generation device in the above-described example embodiments of the present invention using a single calculation processing apparatus (an information processing apparatus or a computer) will be described. However, the availability analysis device may be realized using physically or functionally at least two calculation processing apparatuses. Further, the availability analysis device may be realized as a dedicated apparatus.

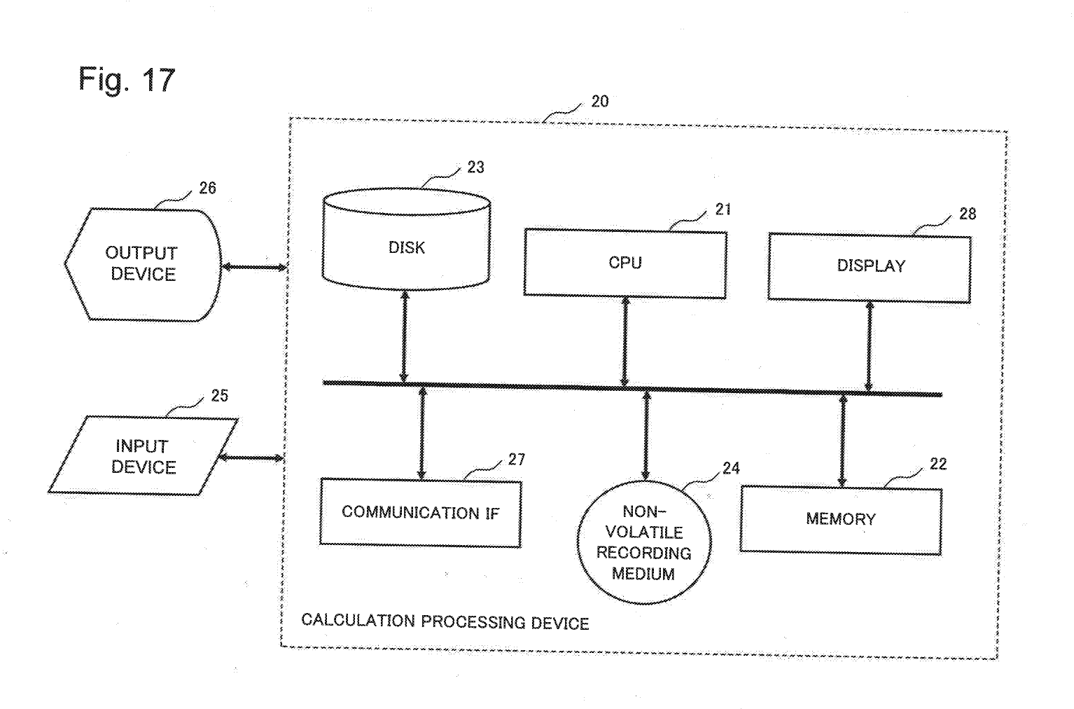

FIG. 17 is a block diagram schematically illustrating a hardware configuration of a calculation processing apparatus capable of realizing the associated information generation device according to each of the first to fourth example embodiments. A calculation processing apparatus 20 includes a central processing unit (CPU) 21, a memory 22, a disc 23, a non-transitory recording medium 24, a communication interface (hereinafter, expressed as a “communication I/F”) 27 and a display 28. A calculation processing apparatus 20 further includes an input apparatus 25 and an output apparatus 26. The calculation processing apparatus 20 can execute transmission/reception of information to/from another calculation processing apparatus and a communication apparatus via the communication I/F 27.

The non-transitory recording medium 24 is, for example, a computer-readable Compact Disc, Digital Versatile Disc, Universal Serial Bus (USB) memory, or Solid State Drive. The non-transitory recording medium 24 allows a related program to be holdable and portable without power supply. The non-transitory recording medium 24 is not limited to the above-described media. Further, a related program can be carried via a communication network by way of the communication I/F 27 instead of the non-transitory medium 24.

In other words, the CPU 21 copies, on the memory 22, a software program (a computer program: hereinafter, referred to simply as a “program”) stored by the disc 23 when executing the program and executes arithmetic processing. The CPU 21 reads data necessary for program execution from the memory 22. When display is needed, the CPU 21 displays an output result on the output apparatus 26. When a program is input from the outside, the CPU 21 reads the program from the input apparatus 25. The CPU 21 interprets and executes an associated information generation program present on the memory 22 corresponding to a function (processing) indicated by each unit illustrated in FIG. 1, FIG. 4, FIG. 9, or FIG. 12 described above or an associated information generation program (FIG. 2, FIG. 5, FIG. 10, or FIG. 13). The CPU 21 sequentially executes the processing described in each example embodiment of the present invention.

In other words, in such a case, it is conceivable that the present invention can also be made using the associated information generation program. Further, it is conceivable that the present invention can also be made using a computer-readable, non-transitory recording medium storing the associated information generation program.

The present invention has been described using the above-described example embodiments as example cases. However, the present invention is not limited to the above-described example embodiments. In other words, the present invention is applicable with various aspects that can be understood by those skilled in the art without departing from the scope of the present invention.

This application is based upon and claims the benefit of priority from Japanese patent application No. 2014-121932, filed on Jun. 13, 2014, the disclosure of which is incorporated herein in its entirety.

### REFERENCE SIGNS LIST

101 Associated information generation device
102 Associated information generation unit
151 Task information storage unit
201 Project information
111 Associated information generation device
112 Reading unit
152 Asset history information storage unit
153 Information input unit
121 Associated information generation device
122 Estimation unit
131 Associated information generation device
132 Estimation unit
141 Associated information
142 Associated information
161 Task information
162 Asset history information
164 Adoption information
165 Exploitation information
166 Conversion information
20 Calculation processing device
21 CPU
22 Memory
23 Disk
24 Non-volatile recording medium
25 Input device
26 Output device
27 Communication IF
28 Display

What is claimed is:

1.-10. (canceled)

11. An associated information generation device comprising:
an associated information generation unit configured to determine, on basis of project information including a task identifier that can uniquely identify a task included in a project, asset information in which the task identifier and a change factor representing a factor of changing a task identified by the task identifier are associated, and task information in which the change factor and a rate at which the change factor occurs are associated, the change factor associated with a specific task identifier included in the project information,
determine the rate associated with the determined change factor, and
generate associated information in which the determined rate and the specific task identifier are associated.

12. The associated information generation device according to claim 11, wherein
the asset information includes a project information set in which, for each project, the task identifier identifying a task included in the project and the change factor are associated,
the associated information generation device further comprises:
a reading unit configured to read the specific project information set that includes the task identifier that matches the task identifier included in the project information, and
the associated information generation unit determines, in the task information, a rate associated with the change factor included in the specific project information set and generates the associated information in which the determined rate regarding the task identifier included in the project information set and the task identifier are associated.

13. The associated information generation device according to claim 12, wherein
in the associated information, the associated information generation unit generates the associated information in which the task identifier and the change factor associated with the task identifier in the specific project information set are associated.

14. The associated information generation device according to claim 12, further comprising:
an estimation unit configured to determine, when the asset information further includes a required time for a change resulting from the change factor associated with the task identifier, the required time associated with the task identifier included in the project information, and calculate an expected value of required time for the task included in the project information on basis of the determined required time and the determined rate,
wherein the associated information generation unit further associates the task identifier included in the project information with the expected value in the associated information.

15. The associated information generation device according to claim 14, wherein
the estimation unit further calculates the expected value on basis of a degree associated with the task identifier included in the project information.

16. The associated information generation device according to claim 14, wherein
the estimation unit determines the project characteristic associated with the task identifier included in the project information on basis of exploitation information in which the task identifier and a project characteristic representing whether or not calculation of the expected value regarding the task identified by the task identifier is based on the rate are associated, determines a degree associated with the determined project characteristic on basis of conversion information in which the project characteristic and the degree are associated, and calculates the expected value on basis of the determined degree.

17. An associated information generation method comprising:
determining, on basis of project information including a task identifier that can uniquely identify a task included in a project, asset information in which the task identifier and a change factor representing a factor of changing a task identified by the task identifier are associated, and task information in which the change factor and a rate at which the change factor occurs are associated, the change factor associated with a specific task identifier included in the project information,
determining the rate associated with the determined change factor, and
generating associated information in which the determined rate and the specific task identifier are associated.

18. A non-volatile recording medium that stores an associated information generation program that causes a computer to implement:
an associated information generation function configured to determine, on basis of project information including a task identifier that can uniquely identify a task included in a project, asset information in which the task identifier and a change factor representing a factor of changing a task identified by the task identifier are associated, and task information in which the change factor and a rate at which the change factor occurs are associated, the change factor associated with a specific task identifier included in the project information,
determine the rate associated with the determined change factor, and
generate associated information in which the determined rate and the specific task identifier are associated.

19. The non-volatile recording medium that stores the associated information generation program according to claim 18, wherein
the asset information includes a project information set in which, for each project, the task identifier identifying a task included in the project and the change factor are associated,
the associated information generation device further comprises:
a reading function configured to read the specific project information set that includes the task identifier that matches the task identifier included in the project information, and
in the associated information generation function, determines, in the task information, a rate associated with the change factor included in the specific project information set and generates the associated information in which the determined rate regarding the task identifier included in the project information set and the task identifier are associated.

20. The non-volatile recording medium that stores the associated information generation program according to claim 19, wherein
in the associated information, the associated information generation function includes a function configured to generate the associated information in which the task identifier and the change factor associated with the task identifier in the specific project information set are associated.
